(19) United States
(12) Patent Application Publication
(10) Pub. No.: US 2003/0236663 A1
(43) Pub. Date: Dec. 25, 2003

(54) Mega speaker identification (ID) system and corresponding methods therefor

(75) Inventors: Nevenka Dimitrova, Yorktown Heights, NY (US); Dongge Li, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/175,391

(22) Filed: Jun. 19, 2002

(51) Int. Cl. G10L 15/00

(52) U.S. Cl. 704/245

(57) ABSTRACT

A memory storing computer readable instructions for causing a processor associated with a mega speaker identification (ID) system to instantiate functions including an audio segmentation and classification function receiving general audio data (GAD) and generating segments, a feature extraction function receiving the segments and extracting features based on mel-frequency cepstral coefficients (MFCC) therefrom, a learning and clustering function receiving the extracted features and reclassifying segments, when required, based on the extracted features, a matching and labeling function assigning a speaker ID to speech signals within the GAD, and a database function for correlating the assigned speaker ID to the respective speech signals within the GAD. The audio segmentation and classification function can assign each segment to one of N audio signal classes including silence, single speaker speech, music, environmental noise, multiple speaker's speech, simultaneous speech and music, and speech and noise. A mega speaker identification (ID) system and corresponding method are also described.

### BACKGROUND OF THE INVENTION

The present invention relates generally to speaker identification (ID) systems. More specifically, the present invention relates to speaker ID systems employing automatic audio signal segmentation based on mel-frequency cepstral coefficients (MFCC) extracted from the audio signals. Corresponding methods suitable for processing signals from multiple audio signal sources are also disclosed.

There currently exist speaker ID systems. More specifically, speaker ID systems based on low-level audio features exists, which systems generally require that the set of speakers be known a priori. In such a speaker ID system, when new audio material is analyzed, it is always categorized into one of the known speaker categories.

It should be noted that there are several groups engaged in research and development regarding methods for automatic annotation of images and videos for content-based indexing and subsequent retrieval. The need for such methods is becoming increasingly important as the desktop PC and the ubiquitous TV converge into a single infotainment appliance capable of bringing unprecedented access to terabytes of video data via the Internet. Although most of the existing research in this area is image-based, there is a growing realization that image-based methods for content-based indexing and retrieval of video needs to be augmented or supplemented with audio-based analysis. This has led to several efforts related to the analysis of the audio tracks in video programs, particularly towards the classification of audio segments into different classes to represent the video content. Several of these efforts are discussed in the papers by N. V. Patel and I. K. Sethi entitled “Audio characterization for video indexing” (Proc. IS&T/SPIE Conf. Storage and Retrieval for Image and Video Databases IV, pp. 373-384, San Jose, Calif. (February 1996)) and “Video Classification using Speaker Identification,” (Proc. IS&T/SPIE Conf Storage and Retrieval for Image and Video Databases V, pp. 218-225, San Jose, Calif. (February 1997)). Additional efforts are described by C. Saraceno and R. Leonardi in their paper entitled “Identification of successive correlated camera shots using audio and video information” (Proc. ICIP97, Vol. 3, pp. 166-169 (997)) and Z. Liu, Y. Wang, and T. Chen in the article “Audio Feature Extraction and Analysis for Scene Classification” (Journal of VLSI Signal Processing, Special issue on multimedia signal processing, pp. 61-79 (October 1998)).

The advances in automatic speech recognition (ASR) are also leading to an interest in classification of general audio data (GAD), i.e., audio data from sources such as news and radio broadcasts, and archived audiovisual documents. The motivation for ASR processing GAD is the realization that by performing audio classification as a preprocessing step, an ASR system can develop and subsequently employ an appropriate acoustic model for each homogenous segment of audio data representing a single class. It will be noted that the GAD subjected to this type of preprocessing results in an improved recognition performance. Additional details are provided in the articles by M. Spina and V. W. Zue entitled “Automatic Transcription of General Audio Data: Preliminary Analyses” (Proc. International Conference on Spoken Language Processing, pp. 594-597, Philadelphia, Pa. (October 1996)) and by P. S. Gopalakrishnan, et al. in “Transcription Of Radio Broadcast News With The IBM Large Vocabulary Speech Recognition System” (Proc. DARPA Speech Recognition Workshop (February 1996)).

Moreover, many audio classification schemes have been investigated in recent years. These schemes mainly differ from each other in two ways: (a) the choice of the classifier; and (2) the set of the acoustical features used by the classifier. The classifiers that have been used in current systems include:

1) Gaussian model-based classifiers, which are discussed in the article by M. Spina and V. W. Zue (mentioned immediately above);

2) neural network-based classifiers, which are discussed in both the article by Z. Liu, Y. Wang, and T. Chen (mentioned above) and by J. H. L. Hansen and Brian D. Womack in their article “Feature analysis and neural network-based classification of speech under stress,” (IEEE Trans. on Speech and Audio Processing, Vol. 4, No. 4, pp. 307-313 (July 1996));

3) decision tree classifiers, which are discussed in the article by T. Zhang and C. -C. J. Kuo entitled “Audio-guided audiovisual data segmentation, indexing, and retrieval” (IS&T/SPIE's Symposium on Electronic Imaging Science & Technology—Conference on Storage and Retrieval for Image and Video Databases VII, SPIE Vol. 3656, pp. 316-327, San Jose, Calif. (January 1999)); and

4) hidden Markov model-based (HMM-based) classifiers, which are discussed in greater detail in both the article by T. Zhang and C. -C. J. Kuo (mentioned immediately above) and the article by D. Kimber and L. Wilcox entitled “Acoustic segmentation for audio browsers” (Proc. Interface Conference, Sydney, Australia (July 1996)).

It will also be noted that the use of both the temporal and the spectral domain features in audio classifiers have been investigated. Examples of the features used include:

1) short-time energy, which is discussed in greater detail in both the article by T. Zhang and C. -C. J. Kuo (mentioned above) and the articles by D. Li and N. Dimitrova entitled “Tools for audio analysis and classification” (Philips Technical Report (August 1997)) and by E. Wold, T. Blum, et al. entitled “Content-based classification, search, and retrieval of audio” (IEEE Multimedia, pp. 27-36 (Fall 1996));

2) pulse metric, which is discussed in greater detail in the articles by S. Pfeiffer, S. Fischer and W. Effelsberg entitled “Automatic audio content analysis” (Proceedings of ACM Multimedia 96, pp. 21-30, Boston, Mass. (1996)) and by S. Fischer, R. Lienhart and W. Effelsberg entitled “Automatic recognition of film genres,” (Proceedings of ACM Multimedia '95, pp. 295-304, San Francisco, Calif. (1995));

3) pause rate, which is discussed in the article regarding audio classification by N. V. Patel et al. (mentioned above);

4) zero-crossing rate, which metric is discussed in greater detail in the previously discussed articles by C. Sraaceno et al. and T. Zhang et al. and in the paper by E. Scheirer and M. Slaney, entitled “Construction and evaluation of a robust multifeature speech/music discriminator,” (Proc. ICASSP 97, pp. 1331-1334, Munich, Germany, (April 1997));

5) normalized harmonicity, which metric is discussed in greater detail in the article by E. Wold et al. (mentioned above with respect to short time energy);

6) fundamental frequency, which metric is discussed in various papers including the papers by Z. Liu et al., T. Zhang et al., E. Wold et al., and S. Pfeiffer et al. mentioned above;

7) frequency spectrum, which is discussed in the article authored by S. Fischer et al. discussed above;

8) bandwidth, which metric is discussed in the papers mentioned above by Z. Lui et al. and E. Wold et al.;

9) spectral centroid, which metric is discussed in the articles by Z. Lui et al., E. Wold et al., and E. Scheirer et al., all of which are discussed above;

10) spectral roll-off frequency (SRF), which is discussed in greater detail in the articles by D. Li et al. and E. Scheirer; and

11) band energy ratio, which metric is discussed in the papers authored by N. V. Patel et al, (regarding audio processing), Z. Lui et al., and D. Li et al.

It should be mentioned that all of the papers and articles discussed above are incorporated herein by reference. Moreover, an additional, primarily mathematical discussion of each of the features discussed above is provided in Appendix A attached hereto.

It will be noted that the article by Scheirer and Slaney describes the evaluation of various combinations of thirteen temporal and spectral features using several classification strategies. The paper reports a classification accuracy of over 90% for a two-way speech/music discriminator, but only about 65% for a three-way classifier that uses the same set of features to discriminate speech, music, and simultaneous speech and music. The articles by Hansen and Womack, and by Spina and Zue report the investigation and classification based on cepstral-based features, which are widely used in the speech recognition domain. In fact, the Spina et al. article suggests the autocorrelation of the Mel-cepstral (AC-Mel) parameters as suitable features for the classification of stress conditions in speech. In contrast, Spina and Zue used fourteen mel-frequency cepstral coefficients (MFCC) to classify audio data into seven categories, i.e., studio speech, field speech, speech with background music, noisy speech, music, silence, and garbage (which covers the rest of audio patterns). Spina et al. tested their algorithm on an hour of NPR radio news and achieved 80.9% classification accuracy.

While many researchers in this field place considerable emphasis on the development of various classification strategies, Scheirer and Slaney concluded that the topology of the feature space is rather simple. Thus, there is very little difference between the performances of different classifiers. In many cases, the selection of features is actually more critical to the classification performance. Thus, while Scheirer and Slaney correctly deduced that classifier development should focus on a limited number of classification metrics, rather than the multiple classifiers suggested by others, they failed to develop either an optimal categorization scheme or an optimal speaker identification scheme for categorized audio frames.

What is needed is a mega speaker identification (ID) system which can be incorporated into a variety of devices, e.g., computers, settop boxes, telephone systems, etc. Moreover, what is needed is a mega speaker identification (ID) method implemented as software functions that can be instantiated on a variety of systems including at least of a microprocessor and a digital signal processor (DSP). Preferably, a mega speaker identification (ID) system and corresponding method, which can easily be scaled up to process general audio data (GAD) derived from multiple audio sources would be extremely desirable.

### SUMMARY OF THE INVENTION

Based on the above and foregoing, it can be appreciated that there presently exists a need in the art for a mega speaker identification (ID) system and corresponding method, which overcome the above-described deficiencies. The present invention was motivated by a desire to overcome the drawbacks and shortcomings of the presently available technology, and thereby fulfill this need in the art.

According to one aspect, the present invention provides a mega speaker identification (ID) system identifying audio signals attributed to speakers from general audio data (GAD) including circuitry for segmenting the GAD into segments, circuitry for classifying each of the segments as one of N audio signal classes, circuitry for extracting features from the segments, circuitry for reclassifying the segments from one to another of the N audio signal classes when required responsive to the extracted features, circuitry for clustering proximate ones of the segments to thereby generate clustered segments, and circuitry for labeling each clustered segment with a speaker ID. If desired, the labeling circuitry labels a plurality of the clustered segments with the speaker ID responsive to one of user input and additional source data. The mega speaker ID system advantageously can be included in a computer, a set-top box, or a telephone system. In an exemplary case, the mega speaker ID system further includes memory circuitry for storing a database relating the speaker ID's to portions of the GAD, and circuitry receiving the output of the labeling circuitry for updating the database. In the latter case, the mega speaker ID system also includes circuitry for querying the database, and circuitry for providing query results. Preferably, the N audio signal classes comprise silence, single speaker speech, music, environmental noise, multiple speaker's speech, simultaneous speech and music, and speech and noise; most preferably, at least one of the extracted features are based on mel-frequency cepstral coefficients (MFCC).

According to another aspect, the present invention provides a mega speaker identification (ID) method permitting identification speakers included in general audio data (GAD) including steps for partitioning the GAD into segments, assigning a label corresponding to one of N audio signal classes to each of the segments, extracting features from the segments, reassigning the segments from one to another of the N audio signal classes when required based on the extracted features to thereby generate classified segments, clustering adjacent ones of the classified segments to thereby generate clustered segments, and labeling each clustered segment with a speaker ID. If desired, the labeling step labels a plurality of the clustered segments with the speaker ID responsive to one of user input and additional source data. In an exemplary case, the method includes steps for storing a database relating the speaker ID's to portions of the GAD, and updating the database whenever new clustered segments are labeled with a speaker ID. It will be appreciated that the method may also include steps for querying the database, and providing query results to a user. Preferably, the N audio signal classes comprise silence, single speaker speech, music, environmental noise, multiple speaker's speech, simultaneous speech and music, and speech and noise. Most preferably, at least one of the extracted features are based on mel-frequency cepstral coefficients (MFCC).

According to a further aspect, the present invention provides an operating method for an mega speaker ID system including M tuners, an analyzer, a storage device, an input device, and an output device, including steps for operating the M tuners to acquire R audio signals from R audio sources, operating the analyzer to partition the N audio signals into segments, to assign a label corresponding to one of N audio signal classes to each of the segments, to extract features from the segments, to reassign the segments from one to another of the N audio signal classes when required based on the extracted features thereby generating classified segments, to cluster adjacent ones of the classified segments to thereby generate clustered segments, and to label each clustered segment with a speaker ID, storing both the clustered segments included in the R audio signals and the corresponding label in the storage device, and generating query results capable of operating the output device responsive to a query input via the input device, where M, N, and R are positive integers. In an exemplary and non-limiting case, the N audio signal classes comprise silence, single speaker speech, music, environmental noise, multiple speaker's speech, simultaneous speech and music, and speech and noise. Moreover, a plurality of the extracted features are based on mel-frequency cepstral coefficients (MFCC).

According to a still further aspect, the present invention provides a memory storing computer readable instructions for causing a processor associated with a mega speaker identification (ID) system to instantiate functions including an audio segmentation and classification function receiving general audio data (GAD) and generating segments, a feature extraction function receiving the segments and extracting features therefrom, a learning and clustering function receiving the extracted features and reclassifying segments, when required, based on the extracted features, a matching and labeling function assigning a speaker ID to speech signals within the GAD, and a database function for correlating the assigned speaker ID to the respective speech signals within the GAD. If desired, the audio segmentation and classification function assigns each segment to one of N audio signal classes including silence, single speaker speech, music, environmental noise, multiple speaker's speech, simultaneous speech and music, and speech and noise. In an exemplary case, at least one of the extracted features are based on mel-frequency cepstral coefficients (MFCC).

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 depicts the characteristic segment patterns for six short segments occupying six of the seven categories (the seventh being silence) employed in the speaker identification (ID) system and corresponding method according to the present invention;

FIG. 2 is a high level block diagram of a feature extraction toolbox which advantageously can be employed, in whole or in part, in the speaker ID system and corresponding method according to the present invention;

FIG. 3 is a high level block diagram of the audio classification scheme employed in the speaker identification (ID) system and corresponding method according to the present invention;

FIGS. 4a and 4b illustrate a two dimensional (2D) partitioned space and corresponding decision tree, respectively, which are useful in understanding certain aspects of the present invention;

FIGS. 5a, 5b, 5c, and 5d are a series of graphs that illustrate the operation of the pause detection method employed in one of the exemplary embodiments of the present invention while FIG. 5e is a flowchart of the method illustrated in FIGS. 5a-5d;

FIGS. 6a, 6b, and 6c collectively illustrate the segmentation methodology employed in at least one of the exemplary embodiments according to the present invention;

FIG. 7 is a graph illustrating the performance of different frame classifiers versus the characterization metric employed;

FIG. 8 is a screen capture of the classification results, where the upper window illustrates results obtained by simplifying the audio data frame by frame while the lower window illustrates the results obtained in accordance with the segmentation pooling scheme employed in at least one exemplary embodiment according to the present invention;

FIGS. 9a and 9b are high-level block diagrams of mega speaker ID systems according to two exemplary embodiments of the present invention;

FIG. 10 is a high-level block diagram depicting the various function blocks instantiated by the processor employed in the mega speaker ID system illustrated in FIGS. 9a and 9b; and

FIG. 11 is a high-level flow chart of a mega speaker ID method according to another exemplary embodiment of the present invention.

### DETAILED DESCRIPTION OF THE PREFERRED EMBODIMENTS

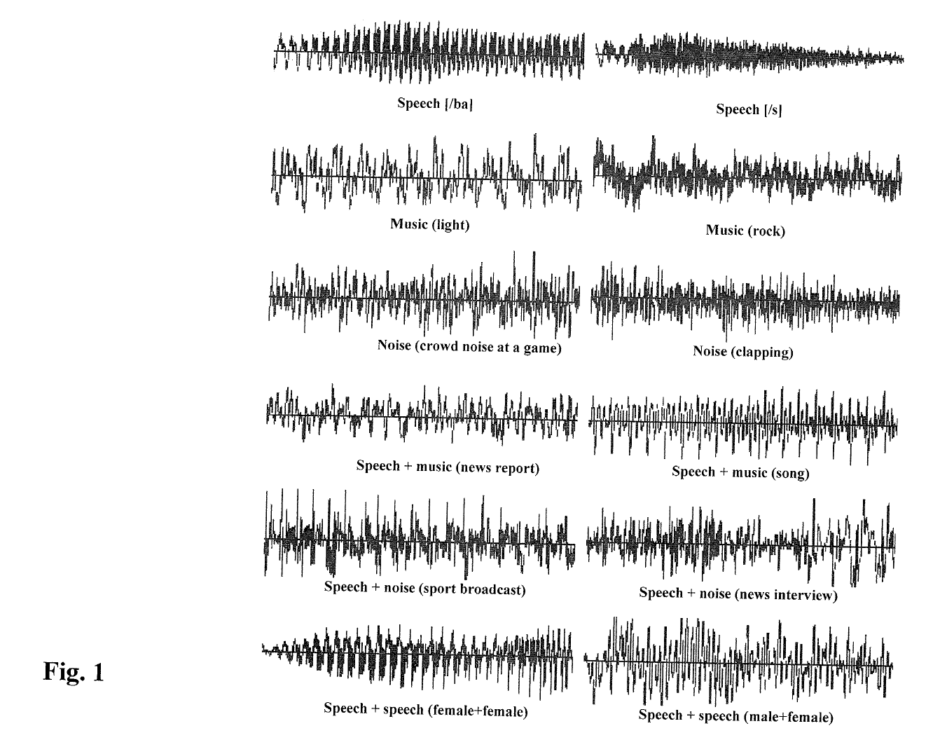

The present invention is based, in part, on the observation by Scheirer and Slaney that the selection of the features employed by the classifier is actually more critical to the classification performance than the classifier type itself. The inventors investigated a total of 143 classification features potentially useful in addressing the problem of classifying continuous general audio data (GAD) into seven categories. The seven audio categories employed in the mega speaker identification (ID) system according to the present invention consist of silence, single speaker speech, music, environmental noise, multiple speakers' speech, simultaneous speech and music, and speech and noise. It should be noted that the environmental noise category refers to noise without foreground sound while the simultaneous speech and music category includes both singing and speech with background music. Exemplary waveforms for six of the seven categories are shown in FIG. 1; the waveform for the silence category is omitted for self-explanatory reasons.

The classifier and classification method according to the present invention parses a continuous bit-stream of audio data into different non-overlapping segments such that each segment is homogenous in terms of its class. Since the transition of audio signal from one category into another can cause classification errors, exemplary embodiments of the present invention employ a segmentation-pooling scheme as an effective way to reduce such errors.

In order to make the development work easily reusable and expandable and to facilitate experiments on different feature extraction designs in this ongoing research area, an auditory toolbox was developed. In its current implementation, the toolbox includes more than two dozens of tools. Each of the tools is responsible for a single basic operation that is frequently needed for the analysis of audio data. By using the toolbox, many of the troublesome tasks related to the processing of streamed audio data, such as buffer management and optimization, synchronization between different processing procedures, and exception handling, become transparent to the users. Operations that are currently implemented in the audio toolbox include frequency-domain operations, temporal-domain operations, and basic mathematical operations such as short time averaging, log operations, windowing, clipping, etc. Since a common communication agreement is defined among all of the tools in the toolbox, the results from one tool can be shared with other types of tools without any limitation. Tools within the toolbox can thus be organized in a very flexible way to accommodate various applications and requirements.

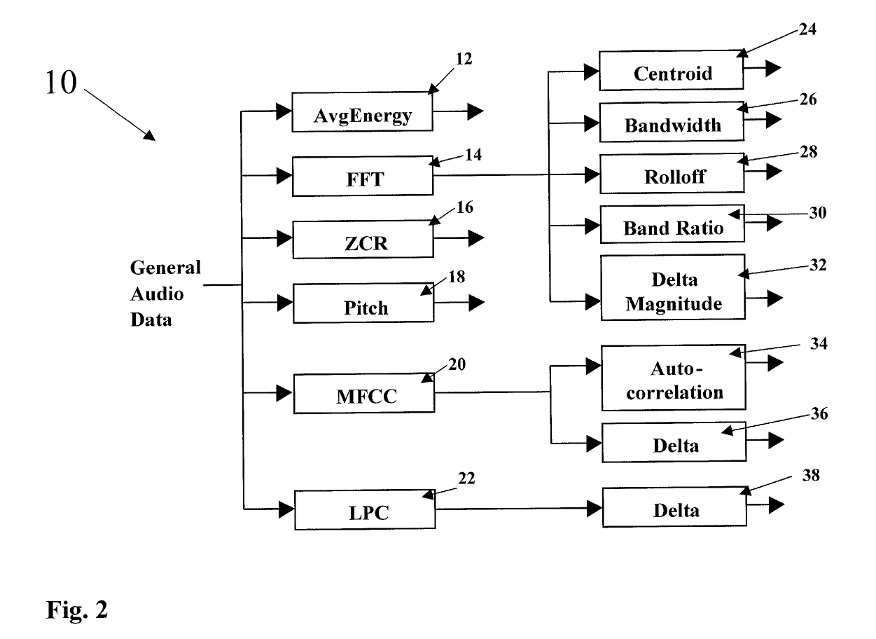

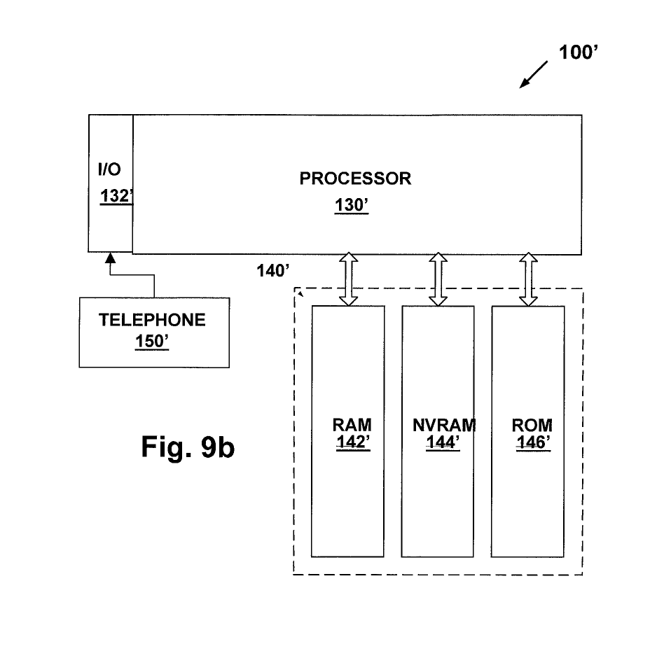

One possible configuration of the audio toolbox discussed immediately above is the audio toolbox 10 illustrated in FIG. 2, which depicts the arrangement of tools employed in the extraction of six sets of acoustical features, including MFCC, LPC, delta MFCC, delta LPC, autocorrelation MFCC, and several temporal and spectral features. The toolbox 10 advantageously can include multiple software modules instantiated by a processor, as discussed below with respect to FIGS. 9a and 9b. These modules include an average energy analyzer (software) module 12, a fast Fourier transform (FFT) analyzer module 14, a zero crossing analyzer module 16, a pitch analyzer module 18, a MFCC analyzer module 20, and a linear prediction coefficient (LPC) analyzer module 22. It will be appreciated that the output of the FFT analyzer module advantageously can be applied to a centroid analyzer module 24, a bandwidth analyzer module 26, a rolloff analyzer module 28, a band ratio analyzer module 30, and a differential (delta) magnitude analyzer module 32 for extracting additional features. Likewise, the output of the MFCC analyzer module 20 can be provided to an autocorrelation analyzer module 34 and a delta MFCC analyzer module 36 for extracting addition features based on the MFCC data for each audio frame. It will be appreciated that the output of the LPC analyzer module 22 can be further processed by a delta LPC analyzer module 38. It will also be appreciated that dedicated hardware components, e.g., one of mode digital signal processors, can be employed when the magnitude of the GAD being processed warrants it or when the cost benefit analysis indicates that it is advantageous to do so. As mentioned above, the definitions or algorithms implemented by these software modules, i.e., adopted for these features, are provided in Appendix A.

Based on the acoustical features extracted from the GAD by the audio toolbox 10, many additional audio features, which advantageously can be used in the classification of audio segments, can be further extracted by analyzing the acoustical features extracted from adjacent frames. Based on extensive testing and modeling conducted by the inventors, these additional features, which correspond to the characteristics of the audio data over a longer term, e.g. 600 ms period instead of a 10-20 ms frame period, are more suitable for the classification of audio segments. The features used for audio segment classification include:

1) The means and variances of acoustical features over a certain number of successive frames centered on the frame of interest.

2) Pause rate: The ratio between the number of frames with energy lower than a threshold and the total number of frames being considered.

3) Harmonicity: The ratio between the number of frames with a valid pitch value and the total number of frames being considered.

4) Summations of energy of the MFCC, delta MFCC, automation MFCC, LPC, and delta LPC extracted features.

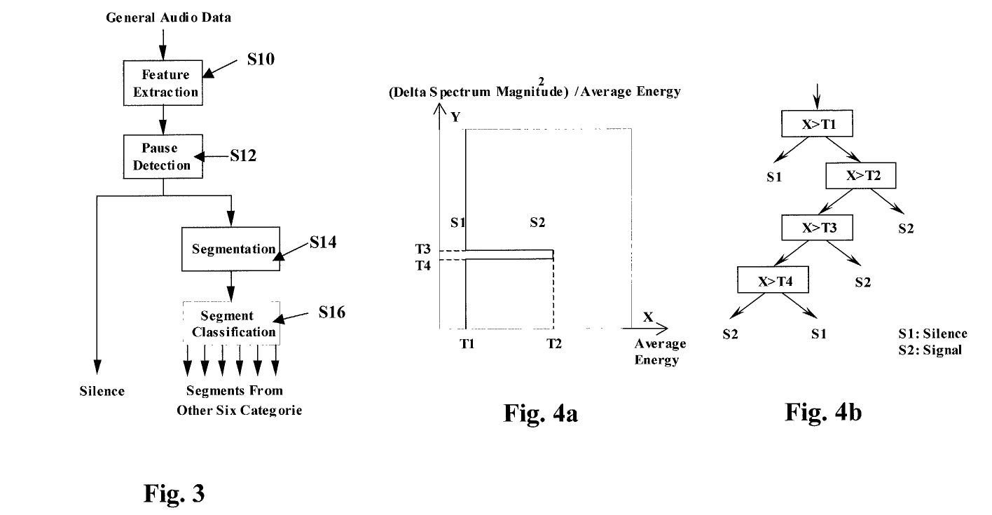

The audio classification method, as shown in FIG. 3, consists of four processing steps: a feature extraction step S10, a pause detection step S12, an automatic audio segmentation step S14, and an audio segment classification step S16. It will be appreciated from FIG. 3 that a rough classification step is performed at step S12 to classify, e.g., identify, the audio frames containing silence and, thus eliminate further processing of these audio frames.

In FIG. 3, feature extraction advantageously can be implemented in step S10 using selected ones of the tools included in the toolbox 10 illustrated in FIG. 2. In other words, during the run time associated with step S10, acoustical features that are to be employed in the succeeding three procedural steps are extracted frame by frame along the time axis from the input audio raw data (in an exemplary case, PCM WAV-format data sampled at 44.1 kHz), i.e., GAD. Pause detection is then performed during step S12.

It will be appreciated that the pause detection performed in step S12 is responsible for separating the input audio clip into silence segments and signal segments. Here, the term “pause” is used to denote a time period that is judged by a listener to be a period of absence of sound, other than one caused by a stop consonant or a slight hesitation. See the article by P. T. Brady entitle “A Technique For Investigating On-Off Patterns Of Speech,” (The Bell System Technical Journal, Vol. 44, No. 1, pp. 1-22 (January 1965)), which is incorporated herein by reference. It will be noted that it is very important for a pause detector to generate results that are consistent with the perception of human beings.

As mentioned above, many of the previous studies on audio classification were performed with audio clips containing data only from a single audio category. However, a “true” continuous GAD contains segments from many audio classes. Thus, the classification performance can suffer adversely at places where the underlying audio stream is making a transition from one audio class into another. This loss in accuracy is referred to as the border effect. It will be noted that the loss in accuracy due to the border effect is also reported in the articles by M. Spina and V. W. Zue and by E. Scheirer and M. Slaney, each of which is discussed above.

In order to minimize the performance losses due to the border effect, the speaker ID system according to the present invention employs a segmentation-pooling scheme implemented at step S14. The segmentation part of the segmentation-pooling scheme is used to locate the boundaries in the signal segments where a transition from one type of audio category to another type of audio category is determined to be taking place. This part uses the so-called onset and offset measures, which indicate how fast the signal is changing, to locate the boundaries in the signal segments of the input. The result of the segmentation processing is to yield smaller homogeneous signal segments. The pooling component of the segmentation-pooling scheme is subsequently used at the time of classification. It involves pooling of the frame-by-frame classification results to classify a segmented signal segment.

In the discussion that follows, the algorithms adopted in pause detection, audio segmentation, and audio segment classification will be discussed in greater detail.

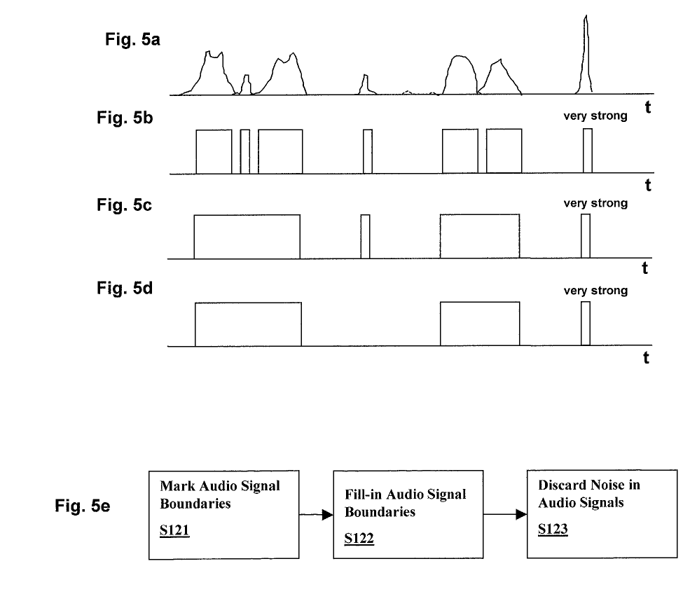

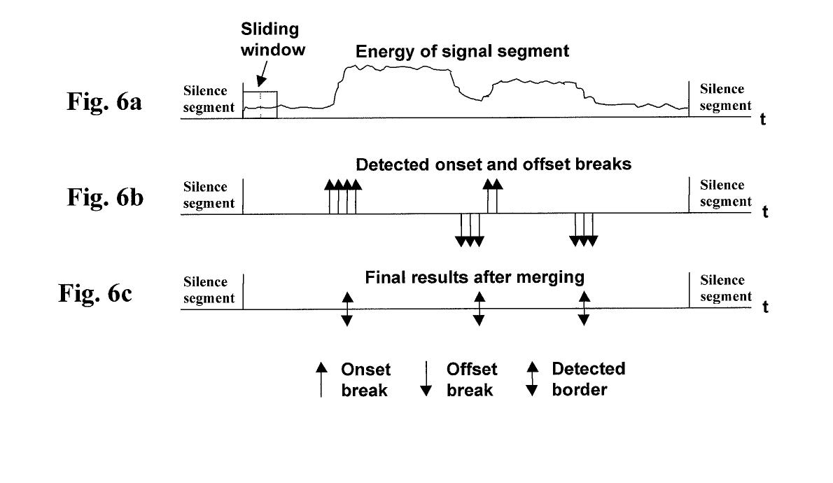

It should be noted that a three-step procedure is implemented for the detection of pause periods from GAD. In other words, step S12 advantageously can include substeps S121, S122, and S123. See FIG. 5e. Based on the features extracted by selected tools in the audio toolbox 10, the input audio data is first marked frame-by-frame as a signal or a pause frame to obtain raw boundaries during substep S121. This frame-by-frame classification is performed using a decision tree algorithm. The decision tree is obtained in a manner similar to the hierarchical feature space partitioning method attributed to Sethi and Sarvarayudu described in the paper entitled “Hierarchical Classifier Design Using Mutual Information” (IEEE Trans. on Pattern Recognition and Machine Intelligence, Vol. 4, No. 4, pp. 441-445 (July 1982)). FIG. 4a illustrates the partitioning result for a two-dimensional feature space while FIG. 4b illustrates the corresponding decision tree employed in pause detection according to the present invention.

It should also be noted that, since the results obtained in the first substep are usually sensitive to unvoiced speech and slight hesitations, a fill-in process (substep S122) and a throwaway process (substep S123) are then applied in the succeeding two steps to generate results that are more consistent with the human perception of pause.

It should be mentioned that during the fill-in process of substep S122, a pause segment, i.e., a continuous sequence of pause frames, having a length less than the fill-in threshold, is relabeled as a signal segment and is merged with the neighboring signal segments. During the throwaway process of substep S123, a segment labeled signal with a signal strength value smaller than a predetermined threshold is relabeled as a silence segment. The strength of a signal segment is defined as:

$$Strength = max ( L , {\sum }_{i}^{L} \frac{s ( i )}{{T}_{1}} ) , \qquad ( 1 )$$

where L is the length of the signal segment and T₁ corresponds to the lowest signal level shown in FIG. 4a. It should be noted that the basic concept behind defining segment strength, instead of using the length of the segment directly, is to take signal energy into account so that segments of transient sound bursts will not be marked as silence during the throwaway process. See the article by P. T. Brady entitled “A Technique For Investigating On-Off Patterns Of Speech” (The Bell System Technical Journal, Vol. 44, No. 1, pp.1-22 (January 1965)). FIGS. 5a-5d illustrate the three steps of the exemplary pause detection algorithm. More specifically, the pause detection algorithm employed in at least one of the exemplary emobodiments of the present invention includes a step S120 for determining the short time energy of input signal (FIG. 5a), determining the candidate signal segments in S121 (FIG. 5b), performing the above-described fill-in substep S122 (FIG. 5c), and performing the above-mentioned throwaway substep S123 (FIG. 5d).

The pause detection module employed in the mega speaker ID system according to the present invention yields two kinds of segments: silence segments; and signal segments. It will be appreciated that the silence segments do not require any further processing because these segments are already fully classified. The signal segments, however, require additional processing to mark the transition points, i.e., locations where the category of the underlying signal changes, before classification. In order to locate transition points, the exemplary segmentation scheme employs a two-substep process, i.e., a break detection substep S141 and a break-merging substep S142, in performing step S14. During the break detection substep S141, a large detection window placed over the signal segment is moved and the average energy of different halves of the window at each sliding position is compared. This permits the detection of two distinct types of breaks:

$$\{ \begin{matrix}Onset break \text{:} if {\overline{E}}_{2} - {\overline{E}}_{1} > {Th}_{1} \\ Offset break \text{:} if {\overline{E}}_{1} - {\overline{E}}_{2} > {Th}_{2}\end{matrix} ,$$

where \overline{E}₁ and \overline{E}₂ are average energy of the first and the second halves of the detection window, respectively. The onset break indicates a potential change in audio category because of an increase in the signal energy. Similarly, the offset break implies a change in the category of the underlying signal because of a lowering of the signal energy. It will be appreciate that since the break detection window is slid along the signal, a single transition in audio category of the underlying signal can generate several consecutive breaks. The merger of this series of breaks is accomplished during the second substep of the novel segmentation process denoted step S14.

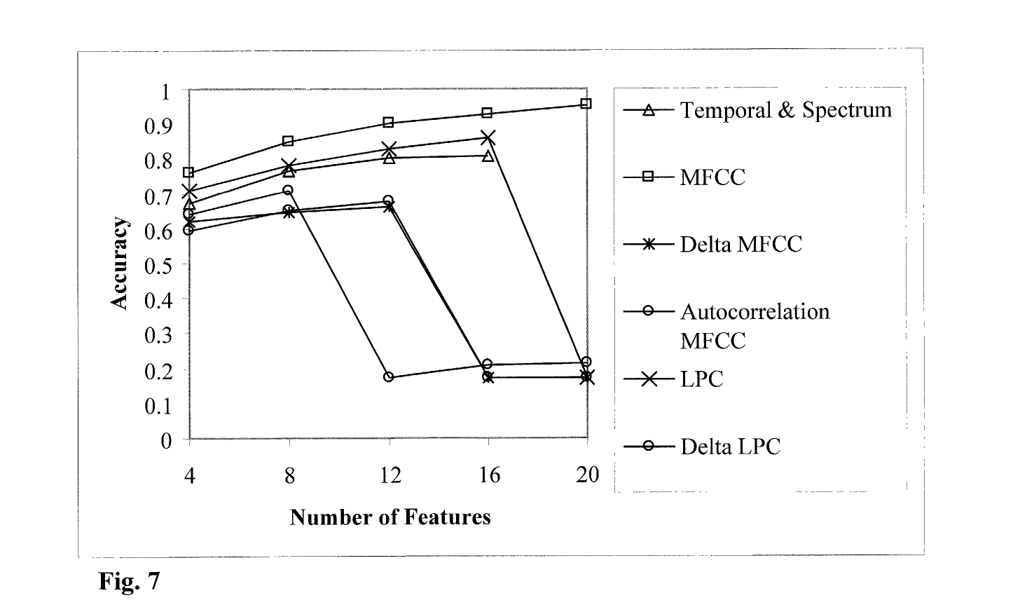

During this substep, i.e., S142, adjacent breaks of the same type are merged into a single break. An offset break is also merged with its immediately following onset break, provided that the two are close to each other in time. This is done to bridge any small gap between the end of one signal and the beginning of another signal. FIGS. 6a, 6b, and 6c illustrate the segmentation process through the detection and merger of signal breaks.

In order to classify an audio segment, the mega speaker ID system and corresponding method according to the present invention first classifies each and every frame of the segment. Next, the frame classification results are integrated to arrive at a classification label for the entire segment. Preferably, this integration is performed by way a pooling process, which counts the number of frames assigned to each audio category; the category most heavily represented in the counting is taken as the audio classification label for the segment.

The features used to classify the frame come not only from that frame but also from other frames, as mentioned above. In an exemplary case, the classification is performed using a Bayesian classifier operating under the assumption that each category has a multidimensional Gaussian distribution. The classification rule for frame classification can be expressed as:

c* =arg min_{c=1.2, . . . ,C}{D²(x,m_{c},S_{c})+ln(det S_{c})−2ln(p_{c})}, (2)

where C is the total number of candidate categories (in this case, C is 6), c* is the classification result, x is the feature vector of the frame being analyzed. The quantities m_{c}, S_{c}, and p_{c} represent the mean vector, covariance matrix, and probability of class c, respectively, and D²(x,m_{c},S_{c}) represents the Mahalanobis distance between x and m_{c}. Since m_{c}, S_{c}, and p_{c} are usually unknown, these values advantageously can be determined using the maximum a posteriori (MAP) estimator, such as that described in the book by R. O. Duda and P. E. Hart entitled “Pattern Classification and Scene Analysis” (John Wiley & Sons (New York, 1973)).

It should be mentioned that the GAD employed in refining the audio feature set implemented in the mega speaker ID system and corresponding method was prepared by first collecting a large number of audio clips from various types of TV programs, such as talk shows, news programs, football games, weather reports, advertisements, soap operas, movies, late shows, etc. These audio clips were recorded from four different stations, i.e., ABC, NBC, PBS, and CBS, and stored as 8-bit, 44.1 kHz WAV-format files. Care was taken to obtain a wide variety in each category. For example, musical segments of different types of music were recorded. From the overall GAD, a half an hour was designated as training data and another hour was designated as testing data. Both training and testing data were then manually labeled with one of the seven categories once every 10 ms. It will be noted that, following the suggestions presented in the articles by P. T. Brady and by J. G. Agnello (“A Study of Intra- and Inter-Phrasal Pauses and Their Relationship to the Rate of Speech,” Ohio State University Ph.D. Thesis (1963)), a minimum duration of 200 ms was imposed on silence segments to thereby exclude intraphase pauses that are normally not perceptible to the listeners. Furthermore, the training data was used to estimate the parameters of the classifier.

In order to investigate the suitability of different feature sets for use in the mega speaker ID system and corresponding method according to the present invention, sixty-eight acoustical features, including eight temporal and spectral features, and twelve each of MFCC, LPC, delta MFCC, delta LPC, and autocorrelation MFCC features, were extracted every 20 ms, i.e., 20 ms frames, from the input data using the entire audio toolbox 10 of FIG. 2. For each of these 68 features, the mean and variance were computed over adjacent frames centered around the frame of interest. Thus, a total of 143 classification features, 68 mean values, 68 variances, pause rate, harmonicity, and five summation features, were computed every 20 ms.

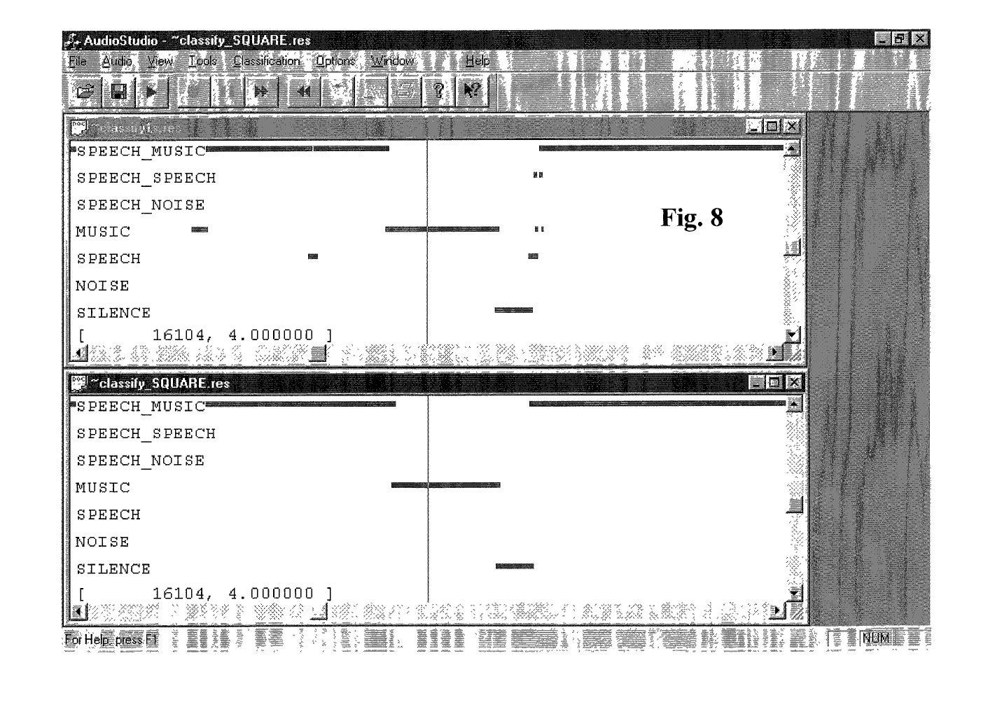

FIG. 7 illustrates the relative performance of different feature sets on the training data. These results were obtained based on an extensive training and testing on millions of promising subsets of features. The accuracy in FIG. 7 is the classification accuracy at the frame level. Furthermore, frames near segment borders are not included in the accuracy calculation. The frame classification accuracy of FIG. 7 thus represents the classification performance that would be obtained if the system were presented segments of each audio type separately. From FIG. 7, it will be noted that different feature sets perform unevenly. It should also be noted that temporal and spectral features do not perform very well. In these experiments, both MFCC and LPC achieve much better overall classification accuracy than temporal and spectral features. With just 8 MFCC features, a classification accuracy of 85.1% can be obtained using the simple MAP Gaussian classifier; it rises to 95.3%, when the number of MFCC features is increased to 20. This high classification accuracy indicates a very simple topology of the feature space and further confirms Scheirer and Slaney's conclusion for the case of seven audio categories. The effect of using a different classifier is thus expected to be very limited.

Table I provides an overview of the results obtained for the three most important feature sets when using the best sixteen features. These results show that the MFCC not only performs best overall but also has the most even performance across the different categories. This further suggests the use of MFCC in applications where just a subset of audio categories is to be recognized. Stated another way, when the mega speaker ID system is incorporated into a device such as a home telephone system, or software for implementing the method is hooked to the voice over the Internet (VOI) software on a personal computer, only a few of the seven audio categories need be implemented.

TABLE 1

| | Classification Accuracy | | | | | |
|---|---|---|---|---|---|---|
| Feature | | | | Speech + | Speech + | Speech + |
| Set | Noise | Speech | Music | Noise | Speech | Music |
| Temporal | 93.2 | 83 | 75.1 | 66.4 | 88.3 | 79.5 |
| & | | | | | | |
| Spectrum | | | | | | |
| MFCC | 98.7 | 93.7 | 94.8 | 75.3 | 96.3 | 94.3 |
| LPC | 96.9 | 83 | 88.7 | 66.1 | 91.7 | 82.7 |

It should be mentioned at this point that a series of additional experiments were conducted to examine the effects of parameter settings. Only minor changes in performance were detected using different parameter settings, e.g., a different windowing function, or varying the window length and window overlap. No obvious improvement in classification accuracy was achieved when increasing the number of MFCC features or using a mixture of features from different features sets.

In order to determine how well the classifier performs on the test data, the remaining one-hour of the data was employed as test data. Using the set of 20 MFCC features, the frame classification accuracy of 85.3% was achieved. This accuracy is based on all of the frames including the frames near borders of audio segments. Compared to the accuracy on the training data, it will be appreciated that there was about a 10% drop in accuracy when the classifier deals with segments from multiple classes.

It should be noted that the above-described experiments were carried out on a Pentium II PC with 266 MHz CPU and 64M of memory. For one hour of audio data sampled at 44.1 kHz, it took 168 seconds of processing time, which is roughly 21 times faster than the playing rate. It will be appreciated that this is a positive predictor of the possibility of including a real time speaker ID system in the user's television or integrated entertainment system.

During the next phase in processing, the pooling process was applied to determine the classification label for each segment as a whole. As a result of the pooling process, some of the frames, mostly the ones near the borders, had their classification labels changed. Comparing to the known frame labels, the accuracy after the pooling process was found to be 90.1%, which represents an increase of about 5% over system accuracy without pooling.

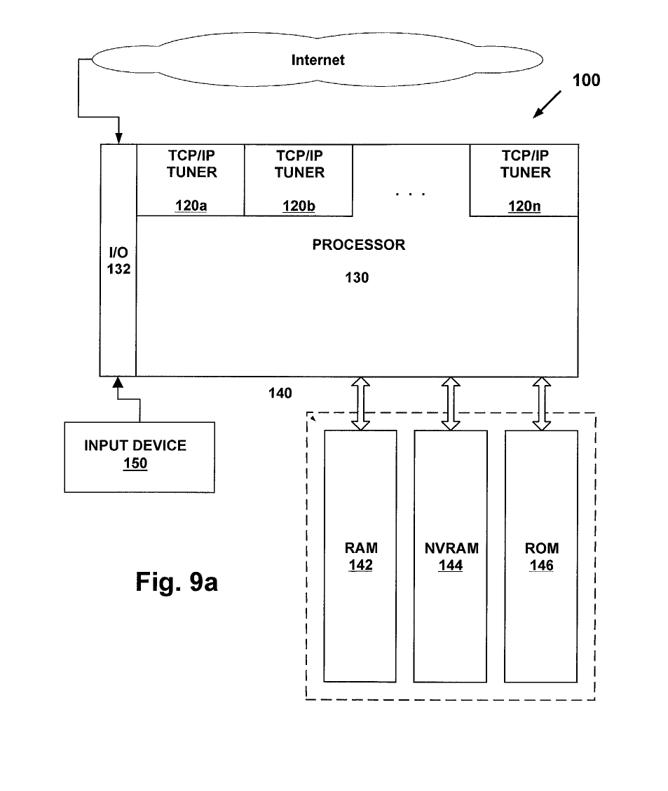

An example of the difference in classification with and without the segmentation-pooling scheme is shown in FIG. 8, where the horizontal axis represents time. The different audio categories correspond to different levels on the vertical axis. A level change represents a transition from one category into another. FIG. 8 demonstrates that the segmentation-pooling scheme is effective in correcting scattered classification errors and eliminating trivial segments. Thus, the segmentation-pooling scheme can actually generate results that are more consistent with the human perception by reducing degradations due to the border effect.

The problem of the classification of continuous GAD has been addressed above and the requirements for an audio classification system, which is able to classify audio segments into seven categories, has been presented in general. For example, with the help of the auditory toolbox 10, tests and comparison were performed on a total of 143 classification features to optimize the employed feature set. These results confirm the observation attributed to Scheirer and Slaney that the selection of features is of primary importance in audio classification. These experimental results also confirmed that the cepstral-based features such as MFCC, LPC, etc., provide a much better accuracy and should be used for audio classification tasks, irrespective of the number of audio categories desired.

A segmentation-pooling scheme was also evaluated and was demonstrated to be an effective way to reduce the border effect and to generate classification results that are consistent with human perception. The experimental results show that the classification system implemented in the exemplary embodiments of the present invention provide about 90% accurate performance with a processing speed dozens of times faster than the playing rate. This high classification accuracy and processing speed enables the extension of the audio classification techniques discussed above to a wide range of additional autonomous applications, such as video indexing and analysis, automatic speech recognition, audio visualization, video/audio information retrieval, and preprocessing for large audio analysis systems, as discussed in greater detail immediately below.

An exemplary embodiment of a mega ID speaker system according to the present invention is illustrated in FIG. 9a, which is high-level block diagram of an audio recorder-player 100, which advantageously includes a mega speaker ID system. It will be appreciated that several of the components employed in audio recorder-player 100 are software devices, as discussed in greater detail below. It will also be appreciated that the audio recorder-player 100 advantageously can be connected to various streaming audio sources; at one point there were as many as 2500 such sources in operation in the United States alone. Preferably, the processor 130 receives these streaming audio sources via an I/O port 132 from the Internet. It should be mentioned at this point that the processor 130 advantageously can be one of a microprocessor or a digital signal processor (DSP); in an exemplary case, the processor 130 can include both types of processors. In another exemplary case, the processor is a DSP which instantiates various analysis and classification functions, which functions are discussed in greater detail both above and below. It will be appreciated from FIG. 9a that the processor 130 instantiates as many virtual tuners, e.g., TCP/IP tuners 120a-120n, as processor resources permit.

It will be noted that the actual hardware required to connect to the Internet includes a modem, e.g., an analog, cable, or DSL modem or the like, and, in some cases, a network interface card (NIC). Such conventional devices, which form no part of the present invention, will not be discussed further.

Still referring to FIG. 9a, the processor 130 is preferably connected to a RAM 142, a NVRAM 144, and ROM 146 collectively forming memory 140. RAM 142 provides temporary storage for data generated by programs and routines instantiated by the processor 130 while NVRAM 144 stores results obtained by the mega speaker ID system, i.e., data indicative of audio segment classification and speaker information. ROM 146 stores the programs and permanent data used by these programs. It should be mentioned that NVRAM 144 advantageously can be a static RAM (SRAM) or ferromagnetic RAM (FERAM) or the like while the ROM 146 can be a SRAM or electrically programmable ROM (EPROM or EEPROM), which would permit the programs and “permanent” data to be updated as new program versions become available. Alternatively, the functions of RAM 142, NVRAM 144, and the ROM 146 advantageously can be embodied in the present invention as a single hard drive, i.e., the single memory device 140. It will be appreciated that when the processor 130 includes multiple processors, each of the processors advantageously can either share memory device 140 or have a respective memory device. Other arrangements, e.g., all DSPs, employ memory device 140 and all microprocessors employ memory device 140A (not shown), are also possible.

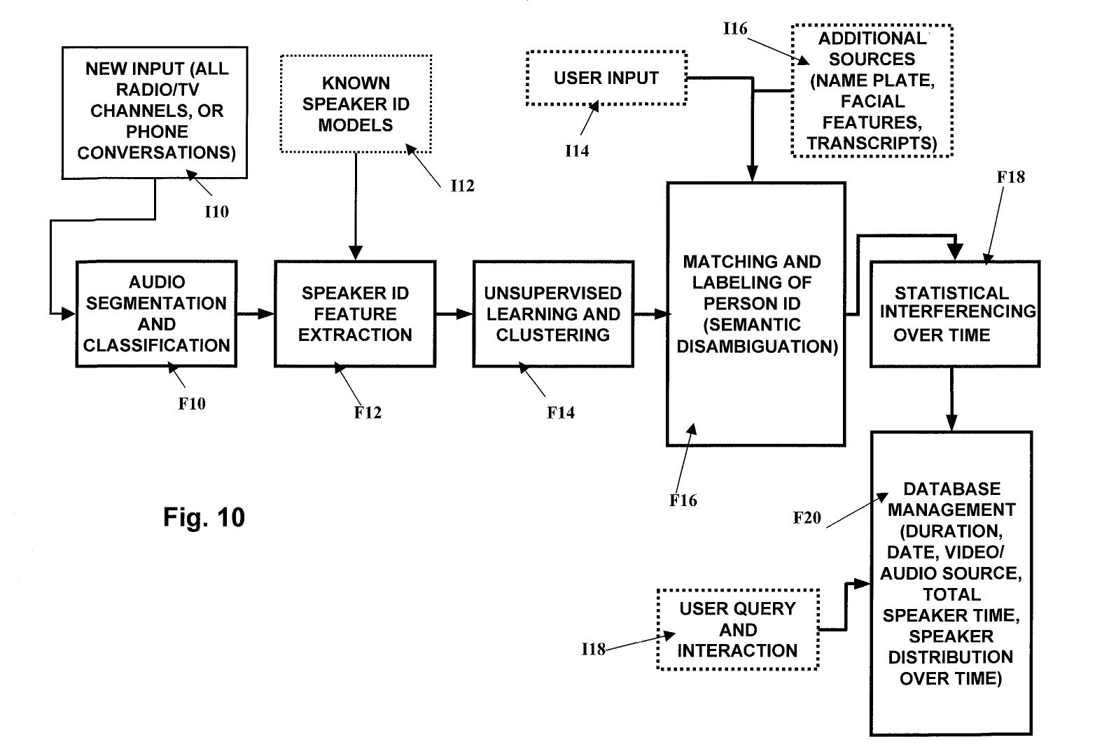

It will be appreciated that the additional sources of data to be employed by the processor 130 or direction from a user advantageously can be provided via an input device 150. As discussed in greater detail below with respect to FIG. 10, the mega speaker ID systems and corresponding methods according to this exemplary embodiment of the present invention advantageously can receive additional data such as known speaker ID models, e.g., models prepared by CNN for its news anchors, reporters, frequent commentators, and notable guests. Alternatively or additionally, the processor 130 can receive additional information such as nameplate data, data from a facial feature database, transcripts, etc., to aid in the speaker ID process. As mentioned above, the processor advantageously can also receive inputs directly from a user. This last input is particularly useful when the audio sources are derived from the system illustrated in FIG. 9b.

FIG. 9b is a high level block diagram of an audio recorder 100′ including a mega speaker ID system according to another exemplary embodiment of the present invention. It will be appreciated that audio recorder 100′ is preferably coupled to single audio source, e.g., a telephone system 150′, the key pad of which advantageously can be employed to provide identification data regarding the speakers at both ends of the conversation. The I/O device 132′, the processor 130′, and the memory 140′ are substantially similar to those described with respect to FIG. 9a, although the size and power or the various components advantageously can be scaled up or back to the application. For example, given the audio characteristics of the typical telephone system, the processor 130′ could be much slower and less expensive than the processor 130 employed in the audio recorder 100 illustrated in FIG. 9a. Moreover, since the telephone is not expected to experience the full range of audio sources illustrated in FIG. 1, the feature set employed advantageously can be targeted to the expected audio source data.

It should be mentioned that the audio recorders 100 and 100′, which advantageously include the speaker ID system according to the present invention, are not limited to use with telephones. The input device 150, 150′ could also be a video camera, a SONY memory stick reader, a digital video recorder (DVR), etc. Virtually any device capable of providing GAD advantageously can be interfaced to the mega speaker ID system or can include software for practicing the mega speaker ID method according to the present invention.

The mega speaker ID system and corresponding method according to the present invention may be better understood by defining the system in terms of the functional blocks that are instantiated by the processors 130, 130′. As shown in FIG. 10, the processor instantiates an audio segmentation and classification function F10, a feature extraction function F12, a learning and clustering function F14, a matching and labeling function F16, a statistical interferencing function F18, and a database function F20. It will be appreciated that each of these “functions” represents one or more software modules that can be executed by the processor associated with the mega speaker ID system.

It will also be appreciated from FIG. 10 that the various functions receive one or more predetermined inputs. For example, the new input I10, e.g., GAD, is applied to audio segmentation and classification function F10 while known speaker ID Model information I12 advantageously can be applied to the feature extraction function F12 as a second input (the output of function F10 being the first). Moreover, the matching and labeling function F18 advantageously can receive either, or both, user input I14 or additional source information I16. Finally, the database function F20 preferably receives user queries I18.

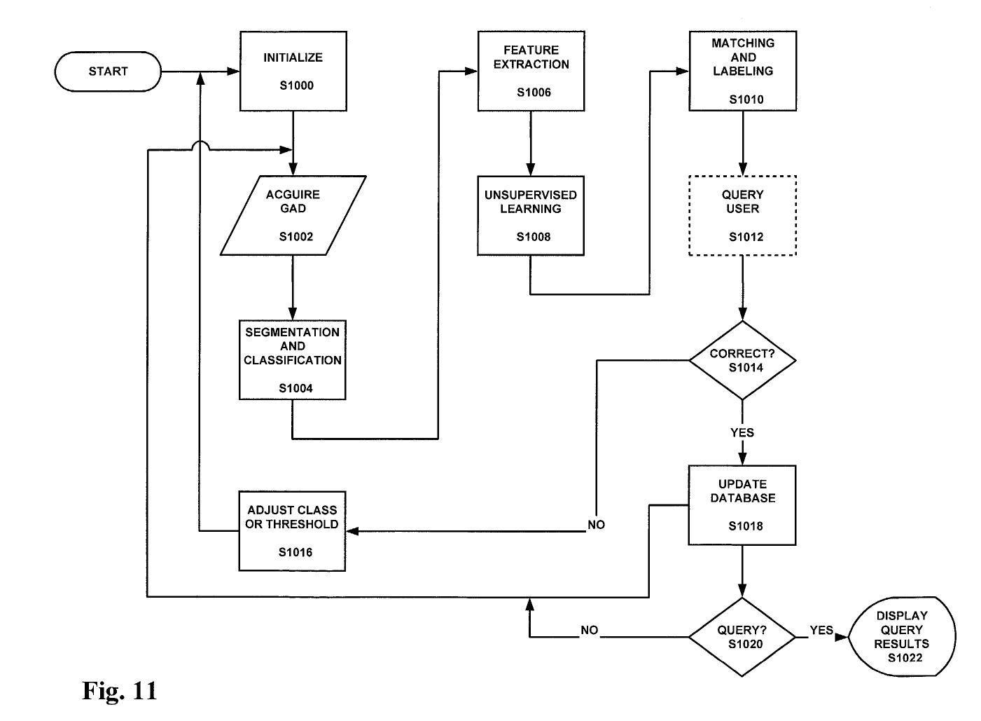

The overall operation of the audio recorder-players 100 and 100′ will now be described while referring to FIG. 11, which illustrates a high-level flowchart of the method of operating an audio recorder-player including the mega speaker ID system according to the present invention. During step S1000, the audio recorder-player and the mega speaker ID system are energized and initialized. For either of the audio recorder-players illustrated in FIGS. 9a and 9b, the initialization routine advantageously can include initializing the RAM 142 (142′) to accept GAD; moreover, the processor 130 (130′) can retrieve both software from ROM 146 (146′) and read the known speaker ID model information I12 and the addition source information I16, if either information type was previously stored in NVRAM 144 (144′).

Next, the new audio source information I10, e.g., GAD, radio or television channels, telephone conversations, etc., is obtained during step S1002 and then segmented into categories: speech; music; silence, etc., by the audio segmentation and classification function F10 during step S1004. The output of function F10 advantageously is applied to the speaker ID feature extraction function F12. During step S1006, for each of the speech segments output by functional block F10, the feature extraction function F12 extracts the MFCC coefficients and classifies it as a separate class (with a different label if required). It should be mentioned that the feature extraction function F12 advantageously can employ known speaker ID model information I12, i.e., information mapping MFCC coefficient patterns to known speakers or known classifications, when such information is available. It will be appreciated that model information I12, if available, will increase the overall accuracy of the mega speaker ID method according to the present invention.

During step S1008, the unsupervised learning and clustering function F14 advantageously can be employed to coalesce similar classes into one class. It will be appreciated from the discussion above regarding FIGS. 4a-6c that the function F14 employs a threshold value, which threshold is either freely selectable or selected in accordance with known speaker ID model I12.

During step S1010, the matching and labeling functional block F18 is performed to visualize the classes. It will be appreciated that while the matching and labeling function F18 can be performed without addition informational input, the operation of the matching and labeling function advantageously can be enhanced when function block 18 receives input from an additional source of text information I16, i.e., obtaining a label from text detection (if a nameplate appeared) or another source such as a transcript, and/or user input information I14. It will be appreciated that the inventive method may include and alternative step S1012, wherein the mega speaker ID method queries the user to confirm the speaker ID is correct.

During step S1014, a check is performed to determine whether the results obtained during step S1010 are correct in the user's assessment. When the answer is negative, the user advantageously can intervene and correct the speaker class, or change the thresholds, during step S1016. The program then jumps to the beginning of step S1000. It will be appreciated that steps S1014 and S1016 provide reconciling steps to get the label associated with the features from a particular speaker. If the answer is affirmative, a database function F20 associated with the preferred embodiments of the mega speaker ID system 100 and 100′ illustrated in FIGS. 9a and 9b, respectively, is updated during step S1018 and then the method jumps back to the start of step S1002 and obtains additional GAD, e.g., the system obtains input from days of TV programming, and steps S1002 through S1018 are repeated.

It should noted that once the database function F20 has been initialized, the user is permitted to query the database during step S1020 and to obtain the results of that query during step S1022. In the exemplary embodiment illustrated in FIG. 9a, the query can be input via the I/O device 150. In the exemplary case illustrated in FIG. 9b, the user may build the query and obtain the results via either the telephone handset, i.e., a spoken query, or a combination of the telephone keypad and a LCD display, e.g., a so-called caller ID display device, any, or all, of which are associated with the telephone 150′.

It will be appreciated that there are multiple ways to represent the information extracted from the audio classification and speaker ID system. One way is to model this information using a simple relational database model. In an exemplary case, a database employing multiple tables advantageously can be employed, as discussed below.

The most important table contains information about the categories and dates. See Table II. The attributes of Table II include an audio (video) segment ID, e.g., TV Anytime's notion of CRID, categories and dates. Each audio segment, e.g. one telephone conversation or recorded meeting, or video segment, e.g. each TV program, can be represented by a row in Table II. It will be noted that the columns represent the categories, i.e., there are N columns for N categories. Each column contains information denoting the duration for a particular category. Each element in an entry (row) indicates the total duration for a particular category per audio segment. The last column represents the date of the recording of that segment, e.g. 20020124.

TABLE II

| | Duration_Of | Duration_Of | Duration_Of | |
|---|---|---|---|---|
| CRID | _Silence | _Music | _Speech | Date |
| 034567 | 207 | 5050 | 2010 | 20020531 |
| 034568 | 100 | 301 | 440 | 20020531 |
| 034569 | 200 | 450 | 340 | 20020530 |

The key for this relational table is the CRID. It will be appreciated that additional columns can be added, one could add columns in Table II for each segment and maintain information such as “type” of telephone conversation, e.g. business or personal, or TV program genre, e.g. news, sports, movies, sitcoms etc. Moreover, an additional table advantageously can be employed to store the detailed information for each category of a specific subsegment, e.g., the beginning, the end time, the category, for the CRID. See Table III. It should be noted that a “Subsegment” is defined as a uniform small chunk of data of the same category in an audio segment. For example, a telephone conversation contains 4 subsegments: starting with Speaker A, then Silence, then Speaker B and Speaker A.

TABLE III

| | | | |
|---|---|---|---|
| CRID | Category | Begin_Time | End_Time |

| | | | |
|---|---|---|---|
| 034567 | Silence | 00:00:00 | 00:00:10 |
| 034567 | Music | 00:00:11 | 00:00:19 |
| 034567 | Silence | 00:00:20 | 00:00:25 |
| 034567 | Speech | 00:00:26 | 00:00:45 |
| . . . | | | |

As mentioned above, while Table II includes columns for categories such as Duration_Of_Silence, Duration_Of_Music, and Duration_Of_Speech, many different categories can be represented. For example, columns for Duration_Of_FathersVoice, Duration_Of_PresidentsVoice, Duration_Of_Rock, Duration_Of_Jazz, etc., advantageously can be included in Table II.

By employing a database of this kind, the user can retrieve information such as average for each category, min, and max for each category and their positions; standard deviation for each program and each category. For the maximum the user can locate the date and answer queries such as:

On which date was employee “A” dominating a teleconference call; or

Did employee “B” speak during the same teleconference call?

By using this information, the user can employ further data mining approaches and find the correlation between different categories, dates, etc. For example, the user can discover patterns such as the time of the day when person A calls person B the most. In addition, correlation between calls to person A followed by calls to person B can also be discovered.

It will be appreciated from the discussion above that the mega speaker ID system and corresponding method according to the present invention are capable of obtaining input from as few as one audio source, e.g., a telephone, and as many as hundreds of TV or audio channels and then automatically segmenting and categorizing the obtained audio, i.e., GAD, into speech, music, silence, noise and combinations of these categories. The mega speaker ID system and corresponding method can then automatically learn from the segmented speech segments. The speech segments are fed into a feature extraction system that labels unknown speakers and, at some point, performs semantic disambiguation for the identity of the person based on the user's input or additional sources of information such as TV station, program name, facial features, transcripts, text labels, etc.

The mega speaker ID system and corresponding method advantageously can be used for providing statistics such as, how many hours did President George W. Bush speak on NBC during 2002 and what was the overall distribution of his appearance? It will noted that the answer to these queries could be presented to the user as a time line the President's speaking time. Alternatively, when the system is built into the user's home telephone device, the user can ask: when was the last time I spoke with my father or who did I talk to the most in 2000 or how many times did I talk to Peter during the last month?

While FIG. 9b illustrates a single telephone 150′, it will be appreciated that the telephone system including the mega speaker ID system and operated in accordance with a corresponding method need not be limited to a single telephone or subscriber line. A telephone system, e.g., a private branch exchange (PBX) system operated by a business advantageously can include the mega speaker ID system and corresponding method. For example, the mega speaker ID software could be linked to the telephone system at a professional's office, e.g., a doctor's office or accountant's office, and interfaced to the professional's billing system so that calls to clients or patients can be automatically tracked (and billed when appropriate). Moreover, the system could be configured to monitor for inappropriate use of the PBX system, e.g., employees making an unusual number of personal calls, etc. From the discussion above, it will be appreciated that a telephone system including or implementing the mega speaker identification (ID) system and corresponding method, respectively, according to the present invention can operate in real time, i.e., while telephone conversations are occurring. It will be appreciated that this latter feature advantageously permits one of the conversation participants to provide user inputs to the system or confirm that, for example, the name of the other party on the user's caller ID system corresponds to the calling actual party.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

[image]

[image]

[image]

What is claimed is:

1. A mega speaker identification (ID) system identifying audio signals attributed to speakers from general audio data (GAD), comprising:
means for segmenting the GAD into segments;
means for classifying each of the segments as one of N audio signal classes;
means for extracting features from the segments;
means for reclassifying the segments from one to another of the N audio signal classes when required responsive to the extracted features;
means for clustering proximate ones of the segments to thereby generate clustered segments; and
means for labeling each clustered segment with a speaker ID.

2. The mega speaker ID system as recited in claim 1, wherein the labeling means labels a plurality of the clustered segments with the speaker ID responsive to one of user input and additional source data.

3. The mega speaker ID system as recited in claim 1, wherein the mega speaker ID system is included in a computer.

4. The mega speaker ID system as recited in claim 1, wherein the mega speaker ID system is included in a set-top box.

5. The mega speaker ID system as recited in claim 1, wherein the mega speaker ID system further comprises:
a memory means for storing a database relating the speaker ID's to portions of the GAD; and
means receiving the output of the labeling means for updating the database.

6. The mega speaker ID system as recited in claim 5, wherein the mega speaker ID system further comprises:
means for querying the database; and
means for providing query results.

7. The mega speaker ID system as recited in claim 1, wherein the N audio signal classes comprise silence, single speaker speech, music, environmental noise, multiple speaker's speech, simultaneous speech and music, and speech and noise.

8. The mega speaker ID system as recited in claim 1, wherein a plurality of the extracted features are based on mel-frequency cepstral coefficients (MFCC).

9. The mega speaker ID system as recited in claim 1, wherein the mega speaker ID system is included in a telephone system.

10. The mega speaker ID system as recited in claim 9, wherein the mega speaker ID system operates in real time.

11. A mega speaker identification (ID) method for identifying speakers from general audio data (GAD), comprising:
partitioning the GAD into segments;
assigning a label corresponding to one of N audio signal classes to each of the segments;
extracting features from the segments;
reassigning the segments from one to another of the N audio signal classes when required based on the extracted features to thereby generate classified segments;
clustering adjacent ones of the classified segments to thereby generate clustered segments; and
labeling each clustered segment with a speaker ID.

12. The mega speaker ID method as recited in claim 11, wherein the labeling step labels a plurality of the clustered segments with the speaker ID responsive to one of user input and additional source data.

13. The mega speaker ID method as recited in claim 1, wherein the method further comprises:
storing a database relating the speaker ID's to portions of the GAD; and
updating the database whenever new clustered segments are labeled with a speaker ID.

14. The mega speaker ID method as recited in claim 13, wherein the method further comprises:
querying the database; and
providing query results to a user.

15. The mega speaker ID method as recited in claim 11, wherein the N audio signal classes comprise silence, single speaker speech, music, environmental noise, multiple speaker's speech, simultaneous speech and music, and speech and noise.

16. The mega speaker ID method as recited in claim 11, wherein a plurality of the extracted features are based on mel-frequency cepstral coefficients (MFCC).

17. An operating method for an mega speaker ID system including M tuners, an analyzer, a storage device, an input device, and an output device, comprising:
operating the M tuners to acquire R audio signals from R audio sources;
operating the analyzer to partition the N audio signals into segments, to assign a label corresponding to one of N audio signal classes to each of the segments, to extract features from the segments; to reassign the segments from one to another of the N audio signal classes when required based on the extracted features thereby generating classified segments, to cluster adjacent ones of the classified segments to thereby generate clustered segments, and to label each clustered segment with a speaker ID;
storing both the clustered segments included in the R audio signals and the corresponding label in the storage device;
generating query results capable of operating the output device responsive to a query input via the input device.
where M, N, and R are positive integers.

18. The operating method as recited in claim 17, wherein the N audio signal classes comprise silence, single speaker speech, music, environmental noise, multiple speaker's speech, simultaneous speech and music, and speech and noise.

19. The operating method as recited in claim 17, wherein a plurality of the extracted features are based on mel-frequency cepstral coefficients (MFCC).

20. A memory storing computer readable instructions for causing a processor associated with a mega speaker identification (ID) system to instantiate functions including:
an audio segmentation and classification function receiving general audio data (GAD) and generating segments;
a feature extraction function receiving the segments and extracting features therefrom;
a learning and clustering function receiving the extracted features and reclassifying segments, when required, based on the extracted features;
a matching and labeling function assigning a speaker ID to speech signals within the GAD; and
a database function for correlating the assigned speaker ID to the respective speech signals within the GAD.

21. The memory as recited in claim 20, wherein the audio segmentation and classification function assigns each segment to one of N audio signal classes including silence, single speaker speech, music, environmental noise, multiple speaker's speech, simultaneous speech and music, and speech and noise.

22. The memory as recited in claim 20, wherein a plurality of the extracted features are based on mel-frequency cepstral coefficients (MFCC).

23. An operating method for an mega speaker ID system receiving M audio signals and operatively coupled to an input device and an output device, the mega speaker ID system including an analyzer and a storage device, comprising:
operating the analyzer to partition an Mth audio signal into segments, to assign a label corresponding to one of N audio signal classes to each of the segments, to extract features from the segments; to reassign the segments from one to another of the N audio signal classes when required based on the extracted features thereby generating classified segments, to cluster adjacent ones of the classified segments to thereby generate clustered segments, and to label each clustered segment with a speaker ID;
storing both the clustered segments included in the audio signals and the corresponding label in the storage device;
generating a database relating the Mth audio signal with statistical information derived from at least one of the extracted features and the speaker ID for the M audio signals analyzed; and
generating query results capable of operating the output device responsive to a query input to the database via the input device,
where M, N, and R are positive integers.

24. The operating method as recited in claim 23, wherein the N audio signal classes comprise silence, single speaker speech, music, environmental noise, multiple speaker's speech, simultaneous speech and music, and speech and noise.

25. The operating method as recited in claim 23, wherein the generating step further comprises generating query results corresponding to calculations performed on selected data stored in the database capable of operating the output device responsive to a query input to the database via the input device.

26. The operating method as recited in claim 23, wherein the generating step further comprises generating query results corresponding to one of statistics on the types of M audio signals, duration of each class, average duration within each class, duration associated with each speaker ID, duration of a selected speaker ID with respect to all speaker IDs reflected in the database, the query results being capable of operating the output device responsive to a query input to the database via the input device.
